(19) United States
(12) Patent Application Publication
(10) Pub. No.: US 2004/0207657 A1
(43) Pub. Date: Oct. 21, 2004

(54) Serving an image in multiple formats from a photohosting website

(76) Inventor: Hugh B. Svendsen, Cary, NC (US)

Correspondence Address: SAWYER LAW GROUP LLP, P.O. Box 51418, Palo Alto, CA, 94303, US

(21) Appl. No.: 10/405,416

(22) Filed: Apr. 2, 2003

(51) Int. Cl. G09G 5/00

(52) U.S. Cl. 345/738; 715/530; 715/501.1; 715/500

(57) ABSTRACT

A method and system for serving an image in multiple formats from a photosharing site is disclosed. The method and system include storing a set of format parameters and respective parameter values in a table. When a request for a modified image containing at least one of the formats is received, the format parameter is looked-up in the table and the value corresponding to the parameter is retrieved. A command line is then automatically generated in which the format value is used as a command line option, and the command line is interpreted to generate the modified image. The modified image is then stored in a cache, and the command line option is used as an identifier in the cache for the modified image.

### FIELD OF THE INVENTION

The present invention relates to photohosting websites, and more particular to a method and system for serving an image in multiple formats from a photosharing website.

### BACKGROUND OF THE INVENTION

The use of photosharing websites that allow users to upload digital images to a server on the Web for storage and display are becoming increasingly popular. Once a set of images have been uploaded to a photosharing site, the photosharing site typically displays the images in the form of an online photo album.

There are many reasons why it is preferable for photosharing sites to generate multiple versions of each uploaded image that may differ from the original in terms of resolution, file type, and style. For example, much smaller versions of the original images, referred to as thumbnails, are usually created for display in the online photo albums in order to increase the speed at which the photo albums may be displayed in the user's Web browser.

Given the storage requirements for storing many different versions of each image, many photosharing websites create the images dynamically, i.e., on demand, and cache those versions of the images that are requested most often.

The photosharing site has a server that is programmed to receive a request for a particular version of an image via standard Web protocols. The code on the server determines if the image has been previously generated, and if not generates the requested version image, and then returns the generated version of the image to the requester.

FIG. 1 is a block diagram illustrating a conventional photosharing system that can serve an image in multiple formats. The system 10 comprises a photosharing site server 12 that responds to requests made from a user's Web browser 14. The server 12 typically includes a database 16 for storing original uploaded images, a temporary database 18, and an image cache 20. Programs that implement the functionality of the server 12 may include a servlet 22, a URL parser 24, a file locator 26, caching logic 28, and an image processing library 30.

In operation, the Web browser 14 displays a web page from the server 12 that may include a link 32 to the original image and a link 34 to a modified version of the original image. If the user clicks the link 32 to the original image, the Web browser 14 sends a URL (uniform resource locator) including the original image ID to the server 12, which will then retrieve the original image from the image database 16 or the cache 20 and return the image to the Web browser 14 for display.

If the user clicks the link 34 to modified image, then the Web browser 14 sends a URL with the image ID and a list of parameters (e.g., resolution, format, and style) specifying how the original image is to be modified. The servlet 22 on the server 12 receives the URL and passes it to the URL parser 24. The URL parser 24 parses to the URL and strips the modification parameters from the URL. Using the image ID, the file loader 26 determines the location of the original image. The caching logic 28 determines if the original image has already been modified as requested by the URL and stored in the cache 20. If the modified image is present in the cache 20, the modified image is returned to the Web browser 14.

If the modified image is not present in the cache 20, then code in the caching logic 28 generates the modified image by interpreting the URL parameters and using the parameters in calls to the image processing library 30. The image processing library 30 then performs the requested changes on the original image to create the modified image. The modified image is then stored in the cache 20, and the caching logic 28 creates a unique cache key for the modified image that will be used to identify and retrieve the modified image from the cache in the future.

Although the system 10 works well for its intended purpose, the system 10 requires an operator of the server 12 to write custom code for the caching logic 28 that interprets each type of URL parameter in order to make the image processing library calls. In order to add or change a parameter, the operator must rewrite and recompile the code, which is time-consuming and requires software expertise.

Accordingly, what is needed is a system for serving multiple image formats in which different image formats may easily be added to the system in a manner that does not require a programmer to implement. The present invention addresses such a need.

### SUMMARY OF THE INVENTION

The present invention provides a method and system for serving an image in multiple formats from a photosharing site. The method and system include storing a set of format parameters and respective parameter values in a table. When a request for a modified image containing at least one of the formats is received, the format parameter is looked-up in the table and the value corresponding to the parameter is retrieved. A command line is then automatically generated in which the format value is used as a command line option, and the command line is interpreted to generate the modified image. The modified image is then stored in a cache, and the command line option is used as an identifier in the cache for the modified image.

In a further aspect of the present invention, when a user is requesting a modified image from a web browser, the format parameters in the table are retrieved and displayed to the user on a web page for selection.

According to the method and system disclosed herein, by storing format parameter and value pairs in a table, referred to as a configuration file, a photosharing website operator need not have a computer science degree to enter new format parameters and values into the system. Thus, the configuration file eliminates the need for a programmer to add custom code to the caching logic for each new format parameter.

### DESCRIPTION OF THE DRAWINGS

FIG. 1 is a block diagram illustrating a conventional photosharing system that can serve an image in multiple formats.

FIG. 2 is a block diagram of a photosharing system that can serve images in multiple formats according to a preferred embodiment of the present invention.

FIGS. 3A and 3B are flow charts illustrating the process performed by the server for serving multiple formats of an image.

FIG. 4 is a diagram illustrating an example configuration file.

FIG. 5 is a block diagram illustrating an example web page displayed to the user for building an online album with modified images.

### DETAILED DESCRIPTION

The present invention relates to serving an image in multiple formats from a photosharing site. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

The present invention provides a method and system for serving an uploaded image in multiple image formats from a photosharing site. Rather than requiring a programmer to write code that interprets URL parameters and makes calls to image processing library, the present invention automatically generates a command line from the URL using a table look-up approach, and uses a command line interpreter to make calls to the image processing library. According to the present invention, a non-programmer can make changes to the look up table, making the system more flexible and easier to maintain for the photosharing site. The use of the look-up table eliminates the need for custom code by on the server.

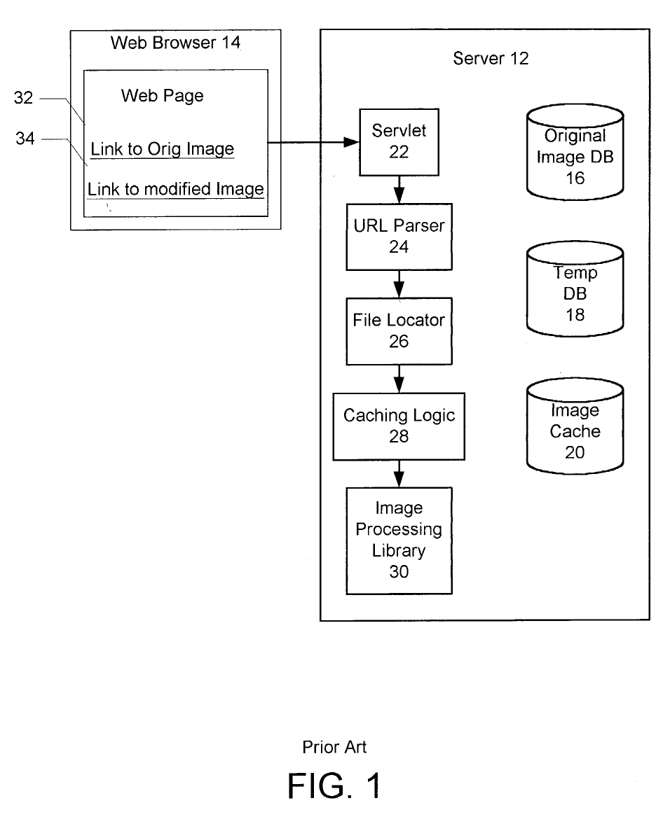

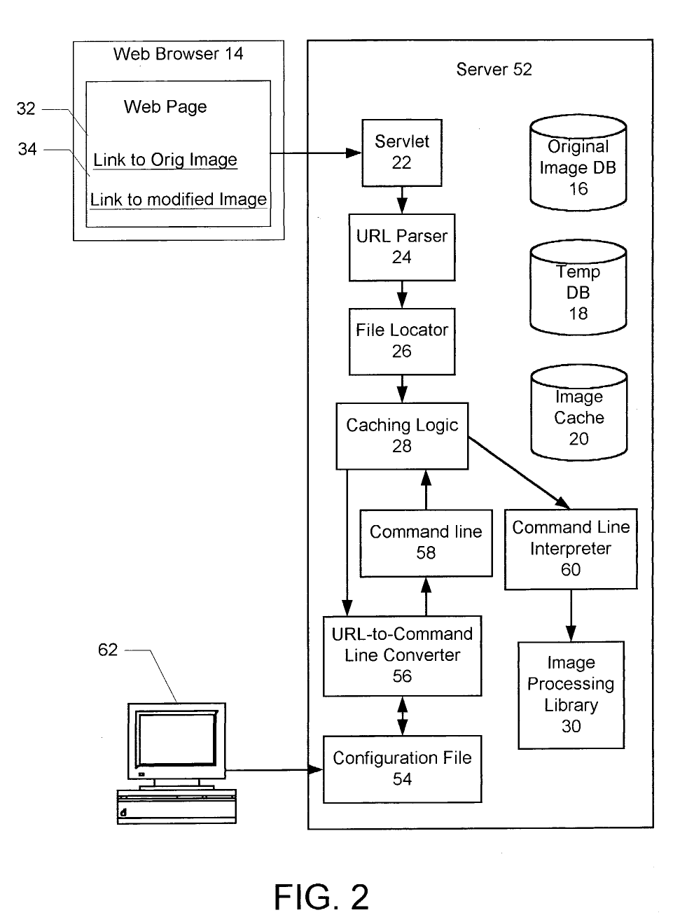

FIG. 2 is a block diagram of a photosharing system 50 that can serve images in multiple formats according to a preferred embodiment of the present invention, where like components from FIG. 1 have like reference numerals. The server 52 includes components similar to that of FIG. 1, but adds a configuration file 54 and a URL-to-command line interpreter 56 for generating a command line 58, and a command line interpreter 60 for interpreting the command line 58. The system further includes a command line console 62 for creating and editing the configuration file 54.

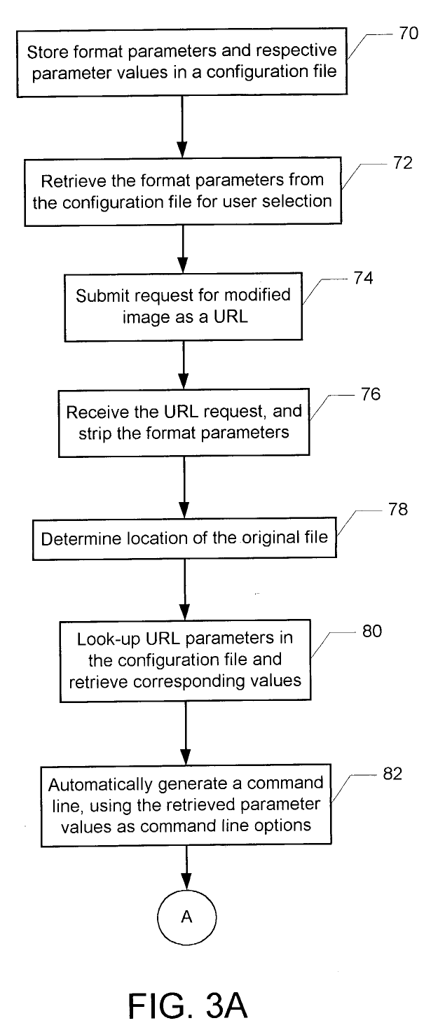

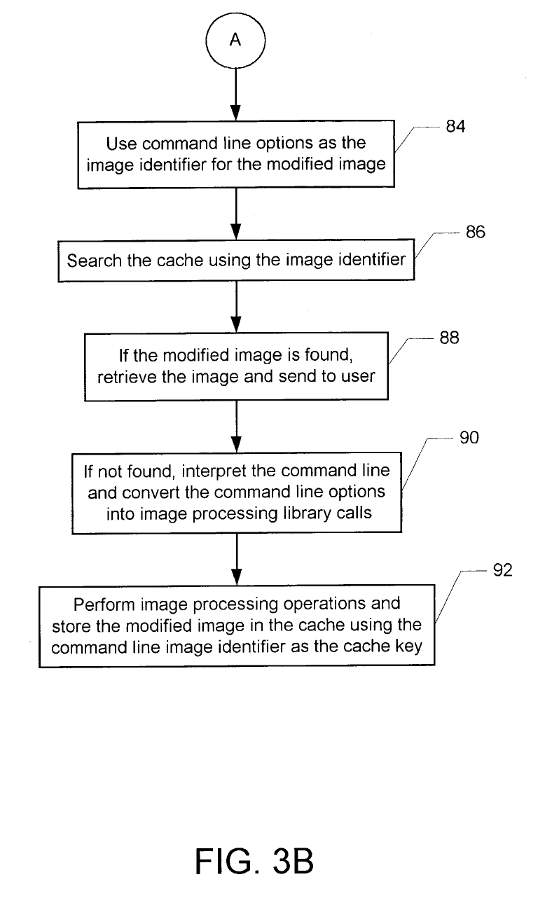

FIGS. 3A and 3B are flow charts illustrating the process performed by the server 52 for serving multiple formats of an image. The process begins in step 70 in which an operator stores a set of format parameters and respective parameter values in the configuration file 54, which will be used as a lookup table during image processing.

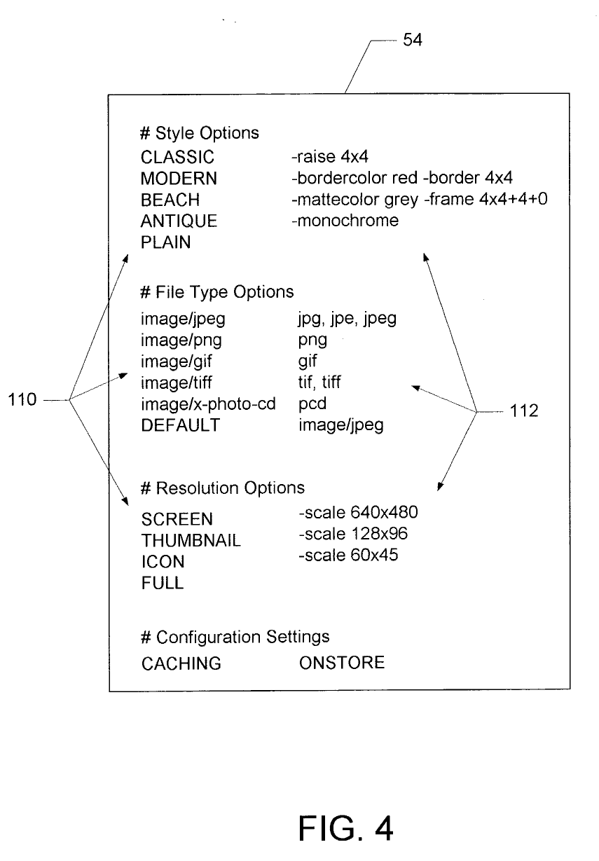

FIG. 4 is a diagram illustrating an example configuration file. In a preferred embodiment, the configuration file 54 stores a set of format parameters 110 and their respective values 112, where the format parameters 110 may be grouped by format option type. Examples of different format options include style, file type, and resolution. Each type of style applies a border/frame or effect to the image. Examples styles include Classic, Modern, Beach, Antique, and Plain. The file type option allows a user to specify a standard, Web-displayable file type for the modified image. Examples of well-known file types include JPEG, PNG, TIFF, GIF, and PhotoCD. In a preferred embodiment the default file type is JPEG. The resolution option allows a user to specify the size of the modified image. Example parameters for the resolution option include Screen, Thumbnail, Icons, and Full.

The configuration file 54 may also include configuration settings that have a caching option that specifies when the modified image will be generated. The caching option may have three possible values: onstore, background, and on request. Onstore means that all specified resolutions would be generated at the time the original image is uploaded. Background means that the specified resolutions will be generated when the server is idle. And on request means that the specified resolutions will be generated upon request.

Referring again to FIG. 3A, when a user is interacting with the server 52 to request a modified image, such as when attempting to build an online album, the server 52 retrieves the format parameters from the configuration file 54 in step 72 and displays the format parameters on a web page for user selection.

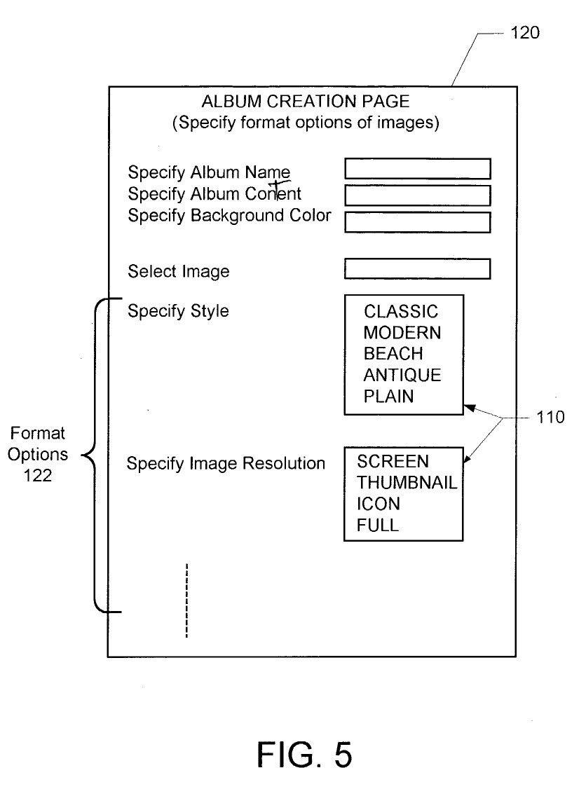

FIG. 5 is a block diagram illustrating an example web page displayed for the user for building an online album with modified images. As shown, the web page 120 allows the user to specify the name, content, and background color for the album, and for each selected image to be included in the album, displays the format options 122 that can be applied to the image. In a preferred embodiment, the parameters for each format option 122 are displayed to the user in pull down lists. For example, to specify an image resolution for the image, the user may select Thumbnail, Screennail, Icon, Full, and User-defined, which are the resolution parameters 110 from the configuration file 54.

Referring again to FIG. 3A, when the user is finished selecting format options 122 for an image, the Web browser 14 submits the request to the server 52 in step 74 as a URL that includes a server ID, an image ID, and the format parameters 110 selected by the user. An example URL for the system 50 is the following:

http://imageserver/servletname?size=THUMBNAIL&filetype=image/JPEG& style=MODERN&id=123

“Size” is a tag specifying the resolution format parameter “THUMBNAIL,” “file type” is a tag specifying the file type format parameter “image/JPEG,” and “format” is a tag specifying the style format parameter “MODERN.”

In step 76, the servlet 22 receives the URL request, and the URL parser 24 strips the format parameters 110 from the URL. In step 78, the file locator 26 determines the location of the original file. In step 80, the caching logic 53 passes the parameters to the URL-to-command line converter 56, which looks up each parameter 110 from the request in the configuration file 54 and retrieves the corresponding values. In step 82, the URL-to-command line converter 56 automatically generates a command line 58 and uses the retrieved parameter values 112 as command line options. An example command line generated from the example URL above is the following:

processimage inputfilename -scale 128×96 -bordercolor red -border 4×4 -o “-scale 128×96 -bordercolor red -border 4×4.jpg”

where “scale 128×96” is the value for the THUMBNAIL format parameter from the configuration file 54, “bordercolor red -border 4×4” is the value for the MODERN file type parameter.

Referring to FIG. 3B, according to another aspect of the present invention, in step 84 the command line options are used as an image identifier for the modified image. In the command line example above, the image name is shown as the last command line option, “-scale 128×96 -bordercolor red -border 4×4.jpg,” which is a concatenation of the other command line options.

In step 86, the caching logic 53 searches the cache 20 based on the image identifier to determine if the modified image has previously been generated. If so, then in step 88 the modified image is retrieved from the cache 20 and sent to the Web browser 14.

If the modified image has not been previously generated, then in step 90 the command line interpreter 60 interprets the command line and converts the command line options into image processing library calls. In step 92, the image processing library 30 performs image processing operations such as scaling, type conversion, rotation, and so on and stores the modified image in the cache 20 and/or the temporary database 18 using the command line image identifier as the cache key.

According to the method and system disclosed herein the command line options retrieves from the configuration file 54 are used as both command line options and the name (or other identifier) to of the modified file. The next time a request is received for that particular modified image, the server 52 constructs the filename and searches the cache 20 for the filename before generating the image.

Using the command line console 62 and operator need not have a computer science degree to enter new format parameters and values into the configuration file 54 to provide users of the server 52 more options when ordering modified images. Thus, the configuration file 54 eliminates the need for a programmer to add custom code to the caching logic 28 for each newly added format parameter.

A method and system for serving an image in multiple formats has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1 A method for serving multiple image formats, the method comprising step of:
(a) storing a set of format parameters and respective parameter values in a table;
(b) when a request for a modified image containing at least one of the format parameters is received, looking up the format in the table and retrieving the corresponding value;
(c) automatically generating a command line in which the format value is used as a command line option; and
(d) interpreting the command line to generate the modified image.

2 The method of claim 1 further including the steps of:
(e) storing the modified image in a cache; and
(f) using the command line option as an identifier in the cache for the modified image.

3 The method of claim 1 further including the step of: when a user is requesting a modified image, retrieving the format parameters from the table and displaying the format parameters on a web page for user selection.

4 The method of claim 1 wherein step (a) further includes the step of: storing the format parameters in a configuration file.

5 The method of claim 4 wherein step (a) further includes the step of: grouping the format parameters in the configuration file by format option type.

6 The method of claim 5 wherein step (a) further includes the step of: including style, file type, and resolution as the format option types.

7 The method of claim 4 wherein instruction (a) further includes the instruction of: providing the configuration file with caching options that specify when the modified image will be generated, the caching options including any combination of at the time an original image is uploaded, when a server is idle, and generated upon request.

8 The method of claim 3 wherein step (b) further includes the step of: receiving the request from a web browser as a URL that includes a server ID, an image ID, and the format parameters selected by the user.

9 The method of claim 2 wherein step (c) further includes the step of: determining if the modified image has previously been generated, and if so, retrieving the modified image and sending the modified image to the requester.

10 A computer readable medium containing program instructions for serving multiple image formats, the program instruction for:
(a) storing a set of format parameters and respective parameter values in a table;
(b) when a request for a modified image containing at least one of the format parameters is received, looking up the format in the table and retrieving the corresponding value;
(c) automatically generating a command line in which the format value is used as a command line option; and
(d) interpreting the command line to generate the modified image.

11 The computer readable medium of claim 10 further including the instructions of:
(e) storing the modified image in a cache; and
(f) using the command line option as an identifier in the cache for the modified image.

12 The computer readable medium of claim 10 further including the instruction of: when a user is requesting a modified image, retrieving the format parameters from the table and displaying the format parameters on a web page for user selection.

13 The computer readable medium of claim 10 wherein instruction (a) further includes the instruction of: storing the format parameters in a configuration file.

14 The computer readable medium of claim 13 wherein instruction (a) further includes the instruction of: grouping the format parameters in the configuration file by format option type.

15 The computer readable medium of claim 14 wherein instruction (a) further includes the instruction of: including style, file type, and resolution as the format option types.

16 The computer readable medium of claim 13 wherein instruction (a) further includes the instruction of: providing the configuration file with caching options that specify when the modified image will be generated, the caching options including any combination of at the time an original image is uploaded, when a server is idle, and generated upon request.

17 The computer readable medium of claim 13 wherein instruction (b) further includes the instruction of: receiving the request from a web browser as a URL that includes a server ID, an image ID, and the format parameters selected by the user.

18 The computer readable medium of claim 12 wherein instruction (c) further includes the instruction of: determining if the modified image has previously been generated, and if so, retrieving the modified image and sending the modified image to the requester.

19 A method for serving multiple image formats, the method comprising step of:
(a) automatically generating a command line in which a format value received with a request for a modified image is used as a command line option;
(b) interpreting the command line to generate the modified image;
(c) storing the modified image in a cache; and
(d) using the command line option as an identifier in the cache for the modified image.
